(19) United States
(12) Patent Application Publication
(10) Pub. No.: US 2008/0117190 A1
(43) Pub. Date: May 22, 2008

(54) METHOD AND DRIVER FOR DRIVING A DISPLAY

(76) Inventors: Chien-Ru Chen, Sinshih Township (TW); Ying-Lieh Chen, Sinshih Township (TW); Lin-Kai Bu, Sinshih Township (TW)

Correspondence Address: PATTERSON & SHERIDAN, L.L.P., 3040 POST OAK BOULEVARD, SUITE 1500, HOUSTON, TX, 77056, US

(21) Appl. No.: 11/562,504

(22) Filed: Nov. 22, 2006

(51) Int. Cl. G06F 3/038

(52) U.S. Cl. 345/204

(57) ABSTRACT

First and second bits of pixel values of the display are received, and each of the first and second bits is forwarded through one of data signals. Then, levels of the data signals are shifted, and the forwarded first and second bits are received through the level-shifted data signals to convert the pixel values into analog voltages driving the display. The level-shifted data signals through which the forwarded first and second bits are received are generated in a first and second phase, respectively.

### BACKGROUND OF THE INVENTION

1. Field of the Invention

The present invention relates to a source driver and the driving method thereof. More particularly, the present invention relates to a driving method and driver in which level-shifted data signals are generated in different phases.

2. Description of the Related Art

FIG. 1 is a conventional source driver 100 used in a liquid crystal display, which illustrates only two channels CH1 and CH2 of the source driver 100 for clarity. In each channel, a first latch circuit 102 obtains bits of pixel values by sampling a signal transmitted through a data bus from a timing controller (not illustrated), in response to a shift register signal (e.g. SR1). A second latch circuit 104 forwards the bits through one data signal in response to a strobe signal (e.g. STB), and a level shift circuit 106 shifts the level of the data signal. A digital-to-analog conversion circuit 108 receives the forwarded bits through the level-shifted data signal to convert the pixel values into an analog voltage for driving the liquid crystal display.

In the conventional design, all second latch circuits 104 in the source driver share the same strobe signal (STB) to forward the bits. However, ground noise is induced when shifting levels of the data signals because the second latch circuits 104 simultaneously forward the bits to their corresponding level shift circuits 106. Moreover, the transistors of the digital-to-analog conversion circuit 108 easily cause GAMMA coupling when too many bits are received from the level shifter circuit 106 at the same time.

### SUMMARY OF THE INVENTION

According to one embodiment of the present invention, a method for driving a display is provided. First and second bits of pixel values of the display are received, and each of the first and second bits is forwarded through one of data signals. Then, levels of the data signals are shifted, and the forwarded first and second bits are received through the level-shifted data signals to convert the pixel values into analog voltages driving the display. The level-shifted data signals through which the forwarded first and second bits are received are generated in a first and second phase, respectively.

According to another embodiment of the present invention, a driver for a display is provided. The driver comprises a first latch circuit, a second latch circuit, a level shift circuit and a digital-to-analog conversion circuit. The first latch circuit obtains first and second bits of pixel values of the display. The second latch circuit forwards each of the first and second bits through one of data signals. The level shift circuit shifts levels of the data signals. The digital-to-analog conversion circuit receives the forwarded first and second bits through the level-shifted data signals to convert the pixel values into analog voltages driving the display. The level-shifted data signals through which the forwarded first and second bits are received are generated in a first and second phase respectively.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a conventional source driver used in a liquid crystal display;

FIG. 2A is a driver for driving a display according to one embodiment of the present invention;

FIG. 2B is a driver for driving a display according to another embodiment of the present invention;

FIG. 3 is a flow chart of a method for driving a display according to one embodiment of the present invention;

FIG. 4A illustrates two strobe signals with a phase difference between them;

FIG. 4B illustrates one strobe signal with rising and falling edges;

FIG. 5A is a level shift circuit according to one embodiment of the present invention;

FIG. 5B illustrates two strobe signals for switching the level shift circuit in FIG. 5A;

FIG. 6A illustrate two strobe signals for different side channels of the display; and

FIG. 6B illustrates one strobe signal for all channels of the display.

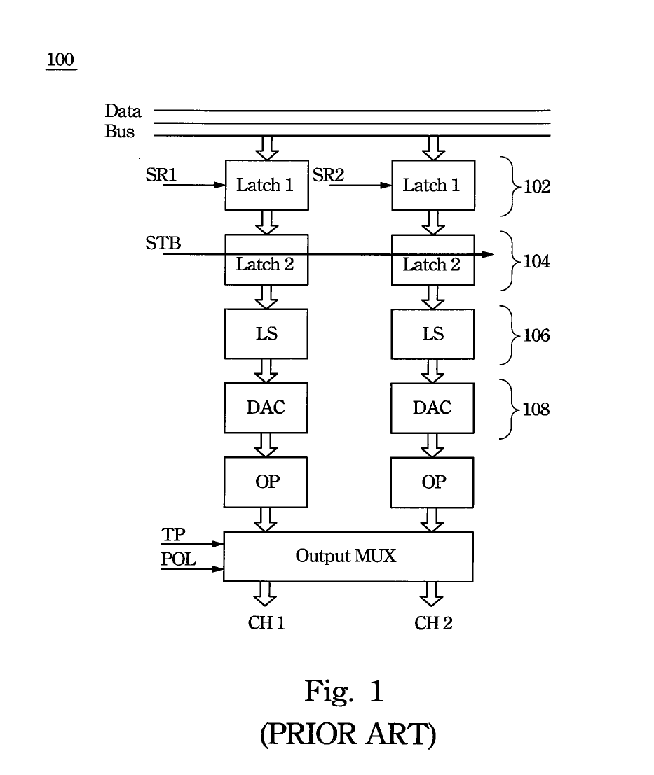

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

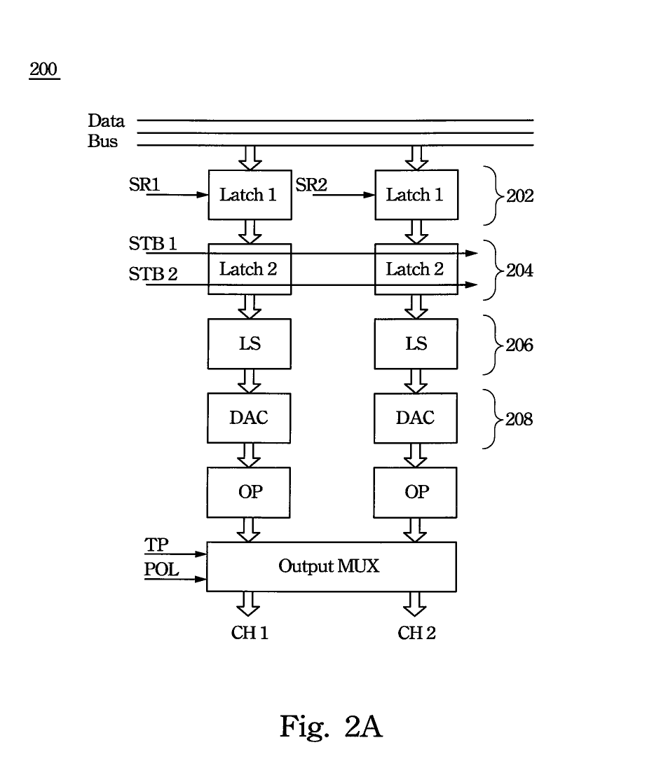

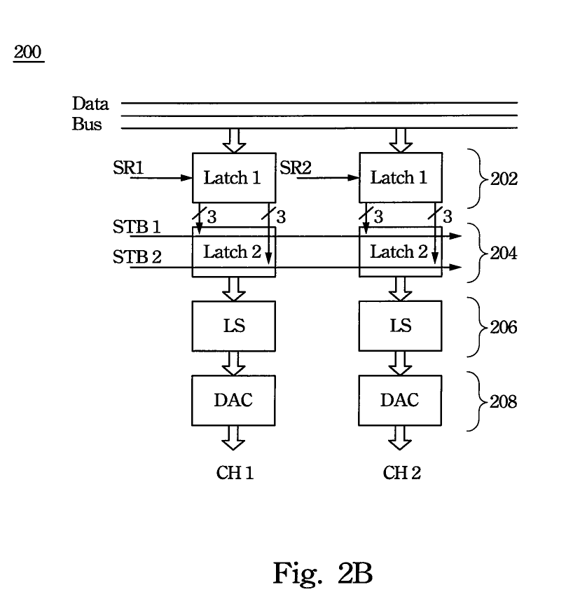

FIG. 2A is a driver for driving a display according to one embodiment of the present invention. The driver 200 has a first latch circuit 202, a second latch circuit 204, a level shift circuit 206 and a digital-to-analog conversion circuit 208. The first latch circuit 202 obtains first and second bits of pixel values of the display. The second latch circuit 204 forwards each of the first and second bits through one of data signals. The level shift circuit 206 shifts levels of the data signals. The digital-to-analog conversion circuit 208 receives the forwarded first and second bits through the level-shifted data signals to convert the pixel values into analog voltages driving the display. The level-shifted data signals through which the forwarded first and second bits are received are generated in a first and second phase respectively.

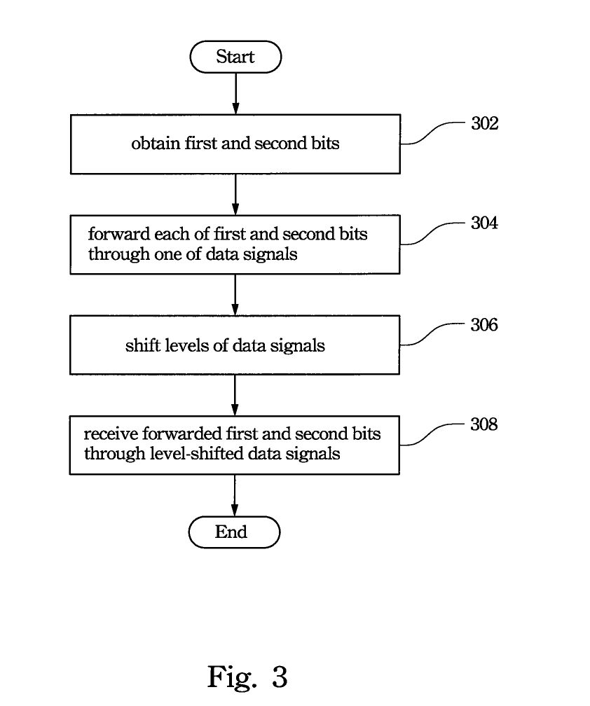

In other words, the embodiment also provides a method for driving the display as illustrated in FIG. 3. Firstly, first and second bits of pixel values of the display are received (step 302), and each of the first and second bits is forwarded through one of data signals (step 304). Then, levels of the data signals are shifted (step 306), and the forwarded first and second bits are received through the level-shifted data signals to convert the pixel values into analog voltages driving the display (step 308). The level-shifted data signals through which the forwarded first and second bits are received are generated in a first and second phase, respectively.

The driver 200a may be, for example, a source driver of a liquid crystal display or other driver used in a display with similar architecture. When the driver 200 is a source driver of a liquid crystal display, the first latch circuit 202 obtains the first and second bits by sampling a signal transmitted through a data bus from a timing controller (not illustrated) of the liquid crystal display. The first latch circuit 202 obtains the first and second bits in sequence, and the second latch circuit 204 temporarily stores the first and second bits before forwarding.

According to the embodiment as illustrated in FIG. 2A, the first and second bits can be bits in odd channels (CH1) and bits in even channels (CH2) of the driver 200, respectively. By using the first and second phases, one for the odd channels and the other for the even channels, the ground noise induced during the level shifting of the data signals can be mitigated because all the level shift circuits 206 do not simultaneously work together.

According to another embodiment as illustrated in FIG. 2B, the first bits include one part of the bits (e.g. three bits) in one of channels of the driver 200 and the second bits include the other part of the bits (e.g. other three bits) in the channel. That is, the first and second bits are referred to bits in the same channel, whether in the odd channel or in the even channel. Therefore, in each of the channels, the first phase is provided for one part of bits, and the second phase is provided for the other part of the bits. By using the first and second phases, not only the ground noise induced during the level shifting can be mitigated, but also the GAMMA coupling caused in the conversion circuit 208 can be reduced because the transistors are not switched by all of the bits in the channel at the same time.

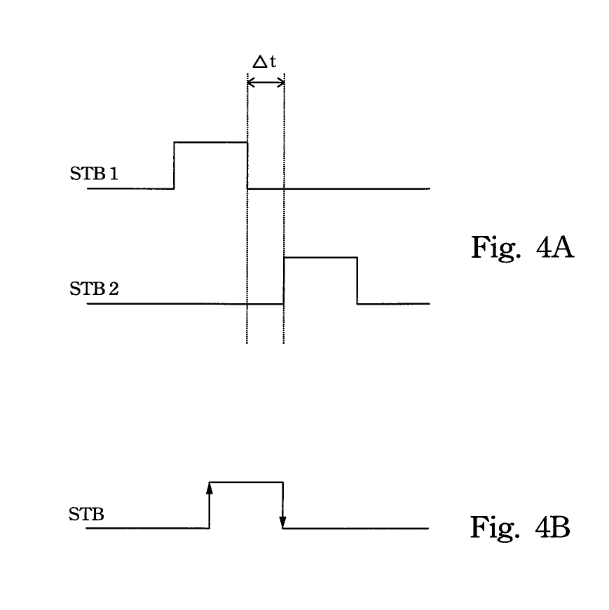

In one aspect, the second latch circuit 204 can forward the first and second bits in parallel in phases corresponding to the first and second phase respectively. For example, the second latch circuit 204 can forward the first and second bits in response to a first strobe signal (STB 1) and second strobe signal (STB 2) respectively, and there is a phase difference (Δt) between the first and second strobe signals (STB 1, STB 2), as illustrated in FIG. 4A.

Alternatively, the second latch circuit 204 can forward the first and second bits on the rising and falling edges of one strobe signal (STB) respectively, as illustrated in FIG. 4B. In this case, the second latch circuit 204 implements an edge trigger circuit, such as a DFF (Delay Flip-Flop), where the first bits (e.g. the bits in odd channels or one part of bits in one channel) are forwarded upon the rising edges of the strobe signal and the second bits (e.g. the bits in even channels or the other part of bits in the channel) are forwarded upon the falling edges of the strobe signal. The ground noise therefore can be mitigated due to the different phases provided from the two edges.

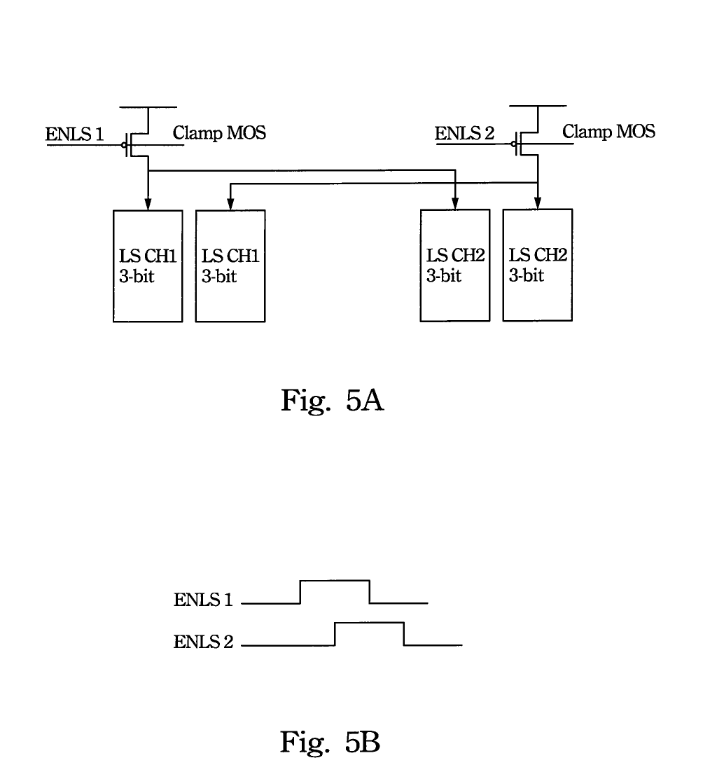

In another aspect, the second latch circuit 204 can forward the first and second bits in parallel in the same phase, and the level shift circuit 206 shifts the levels of the data signals through which the first and second bits are forwarded in phases corresponding to the first and second phase respectively. For example, the level shift circuit 206 shifts the levels of the data signals through which the first and second bits are forwarded in response to a first strobe signal (ENLS 1) and second strobe signal (ENLS 2) respectively, and there is a phase difference between the first and second strobe signals (ENLS 1, ENLS 2), as illustrated in FIGS. 5A and 5B, where six bits in one channel are defined as the first bits and second bits each including three bits.

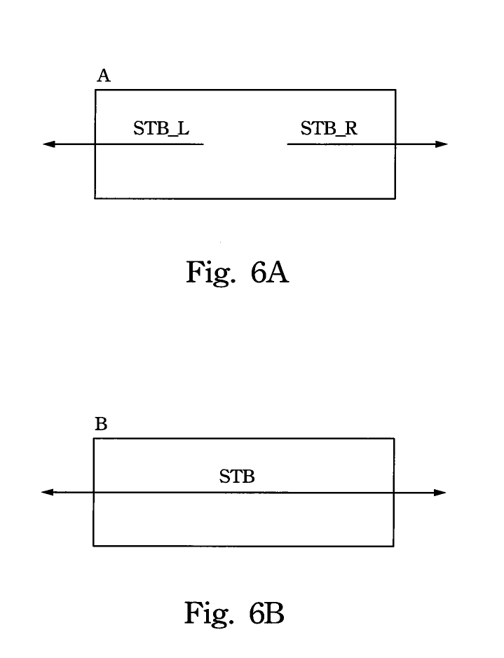

In addition, according to other embodiments of the present invention, the first and second bits can be bits on the left-side channel and the right-side channel of the driver respectively. That is, all channels of the display can be divided into two parts, the left-side channels and the right-side channels, and the strobe signals as stated in the above embodiments, such as two strobe signals (e.g. STB_L, STB_R) for different side channels illustrated in FIG. 6A or one strobe signal (e.g. STB) for all channels illustrated in FIG. 6B, can be implemented here to provide two different phases to mitigate the ground noise and reduce the gamma coupling.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for driving a display comprising the steps of:
obtaining first and second bits of pixel values of the display;
forwarding each of the first and second bits through one of data signals;
shifting levels of the data signals; and
receiving the forwarded first and second bits through the level-shifted data signals to convert the pixel values into analog voltages driving the display;
wherein the level-shifted data signals through which the forwarded first and second bits are received are generated in a first and second phase respectively.

2. The method as claimed in claim 1 wherein the display is a liquid crystal display.

3. The method as claimed in claim 2 wherein the first and second bits are obtained by sampling a signal transmitted through a data bus from a timing controller of the liquid crystal display.

4. The method as claimed in claim 3 wherein the first and second bits are obtained in sequence.

5. The method as claimed in claim 4 further comprising the step of temporarily storing the first and second bits before the step of forwarding.

6. The method as claimed in claim 5 wherein the first and second bits are forwarded in parallel in phases corresponding to the first and second phase respectively.

7. The method as claimed in claim 6 wherein the first and second bits are forwarded in response to a first and second strobe signal respectively, and there is a phase difference between the first and second strobe signals.

8. The method as claimed in claim 6 wherein the first and second bits are forwarded upon a rising and falling edges of a strobe signal respectively.

9. The method as claimed in claim 5 wherein the first and second bits are forwarded in parallel in a same phase.

10. The method as claimed in claim 9 wherein the levels of the data signals through which the first and second bits are forwarded are shifted in phases corresponding to the first and second phase respectively.

11. The method as claimed in claim 10 wherein the levels of the data signals through which the first and second bits are forwarded are shifted in response to a first and second strobe signal respectively, and there is a phase difference between the first and second strobe signals.

12. The method as claimed in claim 1 wherein the first and second bits are bits in odd and even channels of a source driver of the display respectively.

13. The method as claimed in claim 1 wherein the first bits comprise at least a part of bits in one of channels of a source driver of the display and the second bits comprise the other part of the bits in the channel.

14. The method as claimed in claim 1 wherein the first and second bits are bits in left-side and right-side channels of a source driver of the display respectively.

15. A driver for a display comprising:
a first latch circuit obtaining first and second bits of pixel values of the display;
a second latch circuit forwarding each of the first and second bits through one of data signals;
a level shift circuit shifting levels of the data signals; and
a digital-to-analog conversion circuit receiving the forwarded first and second bits through the level-shifted data signals to convert the pixel values into analog voltages driving the display;
wherein the level-shifted data signals through which the forwarded first and second bits are received are generated in a first and second phase respectively.

16. The driver as claimed in claim 15 wherein the display is a liquid crystal display.

17. The driver as claimed in claim 16 wherein the first latch circuit obtains the first and second bits by sampling a signal transmitted through a data bus from a timing controller of the liquid crystal display.

18. The driver as claimed in claim 17 wherein the first latch circuit obtains the first and second bits in sequence.

19. The driver as claimed in claim 18 wherein the second latch circuit temporarily stores the first and second bits before forwarding.

20. The driver as claimed in claim 19 wherein the second latch circuit forwards the first and second bits in parallel in phases corresponding to the first and second phase respectively.

21. The driver as claimed in claim 20 wherein the second latch circuit forwards the first and second bits in response to a first and second strobe signal respectively, and there is a phase difference between the first and second strobe signals.

22. The driver as claimed in claim 20 wherein the second latch circuit forwards the first and second bits upon a rising and falling edges of a strobe signal respectively.

23. The driver as claimed in claim 19 wherein the second latch circuit forwards the first and second bits in parallel in a same phase.

24. The driver as claimed in claim 23 wherein the level shift circuit shifts the levels of the data signals through which the first and second bits are forwarded in phases corresponding to the first and second phase respectively.

25. The driver as claimed in claim 24 wherein the level shift circuit shifts the levels of the data signals through which the first and second bits are forwarded in response to a first and second strobe signal respectively, and there is a phase difference between the first and second strobe signals.

26. The driver as claimed in claim 15 wherein the first and second bits are bits in odd and even channels of the driver respectively.

27. The driver as claimed in claim 15 wherein the first bits comprise at least a part of bits in one of channels of the driver and the second bits comprise the other part of the bits in the channel.

28. The method as claimed in claim 15 wherein the first and second bits are bits in left-side and right-side channels of the driver respectively.
